(19) United States
(12) Patent Application Publication
(10) Pub. No.: US 2017/0028422 A1
(43) Pub. Date: Feb. 2, 2017

(54) Bottle, System Comprising Such a Bottle, and Method for the Production Thereof

(71) Applicant: QUALIPAC, Neuilly Sur Seine (FR)

(72) Inventor: Gérald Martines, Paris (FR)

(73) Assignee: QUALIPAC, Neuilly Sur Seine (FR)

(21) Appl. No.: 15/302,835

(22) PCT Filed: Apr. 8, 2015
(86) PCT No.: PCT/FR2015/050908

§ 371 Date: Oct. 7, 2016

(30) Foreign Application Priority Data
Apr. 8, 2014 (FR) 1453103

(51) Int. Cl. B05B 11/00; B65D 81/32; B65D 21/02; B65D 1/04

(52) U.S. Cl. CPC B05B 11/3085; B65D 1/04; B65D 81/3283; B65D 81/3288; B65D 21/0201; B05B 11/0037

(57) ABSTRACT

A system comprising such a bottle, and a method for the production thereof. The bottle comprises: a glass container system with a single glass container body; a closure system hermetically assembled to the glass container system. The glass container system and the closure system define two different receptacles sealed in relation to one another. In addition, the bottle comprises a product dispensing system for discharging the product contained in the receptacles from the bottle.

The invention relates to the field of bottles, systems comprising such a bottle, and methods for the production of such bottles.

The term “bottle” is used here to designate a rigid object intended to hold fluid content (liquid, viscous, or pasty) to be dispensed. Such a bottle may have a closed and sealed configuration in which the fluid cannot freely leave the bottle. Such a bottle may also be placed in a dispensing configuration, in which the content is dispensed from the bottle. Such bottles are used in the field of cosmetics or spirits.

There are two broad categories of such bottles. In a first category, the bottle comprises a cover that can be separated from the container body, allowing the user direct access to the product contained therein. An example of such an embodiment is, for example, DE 20 2010 015 932 U. To access the content, the cover is detached (often by screwing) from the container body, after which the content is accessible, which in the case presented is a previously mixed single dose to be swallowed. Other examples of bottles with a removable cover include, for example, FR 850 370 where the stopper has pipette tubes filled with two different materials to be mixed in situ to dissolve ink. Yet another example can be found in the salt-and-pepper shaker of BE 333,327, where the lid can be removed in order to refill the salt and pepper from a reserve.

However, such embodiments allow access to the content until the user has closed the bottle, which is not always desirable. Indeed, there are significant risks of closing the bottle incorrectly, which can be detrimental to the content, or of spilling while it is open.

There is thus a second bottle category in which the cover is permanently assembled to the container body, access to the product being achieved by means of a dedicated device. Direct access to the product contained in the bottle is essentially prohibited.

Rigid plastic bottles exist which allow great freedom in the shape or manufacturing method. One may refer for example to EP 0,839,580, which describes a plastic bottle comprising two separate containers each holding a product to be dispensed simultaneously. Conversely, EP 0,758,615 provides for selectively dispensing the products contained in the two separate receptacles of the plastic bottle. EP 0,676,339 provides for user selection of the proportion of the two products contained in the two separate receptacles of the plastic bottle. US 2010/116,769 also discloses various embodiments of a plastic bottle for sports drinks, in two receptacles, which the user must compress to force out one or the other of the contents. Plastic bottles are not suitable for some market segments, however, where bottles including a glass container are traditionally used. However, glass is a material that is difficult to implement from an industrial point of view, due to its demanding manufacturing process (in particular the high temperatures), which can result in wide dispersion in the resulting products due to manufacturing tolerances. This wide dispersion poses problems when it comes to achieving reliable and durable sealing of the bottle in its closed configuration. Although US 2010/116,769 also claims that glass is possible as the component material of this sports drink bottle, it is immediately apparent from the description of the various functions required for this product that glass material is not appropriate.

To reduce the abovementioned problems concerning the fluidtightness of glass products, a blowing process is traditionally used which allows defining a glass container of large capacity, with a narrow neck where the sealing function is implemented. As the glass neck is narrow, it is possible to oversize the sealing solution to ensure that a fluidtight bottle is provided despite the dispersion in the manufacturing process. One exemplary embodiment is, for example, FR 2,952,913.

Recently, there have been efforts to move away from the traditional shape of glass bottles having a narrow neck. A process called “direct press” was presented in EP 2,602,232. This process can certainly be supplemented with a blowing step where appropriate, but the basic geometry of the glass container is still able to provide a large opening in comparison to traditional necks. With such large openings, sealing issues become complex. This direct press method also allows providing different cross-sectional profiles of the opening, and in particular non-circular profiles. For such profiles, due to the non-uniformity of the periphery, the sealing issues are again complex.

Furthermore, there is always a search for ways to diversify bottle product lines and enhance existing bottles with new features, to enable the development of innovative products.

A description of the invention is provided below.

The invention relates to a bottle comprising:
a glass container system comprising a single glass container body,
a closure system hermetically and permanently assembled to the glass container body, the glass container body and the closure system being assembled to each other so as to define at least first and second separate receptacles that are sealed in relation to one another,
a product dispensing system being provided in at least one among the glass container body and the closure system, for discharging the product that may be contained in the receptacles.

With these arrangements, a bottle having a glass container body is provided that is therefore suitable for the applications referred to above, while offering new features.

According to one embodiment, the product dispensing system is provided in at least one among the glass container body and the closure system.

According to one embodiment, the product dispensing system comprises a first dispensing sub-system for discharging the product that may be contained in the first receptacle, and a second dispensing sub-system for discharging the product that may be contained in the second receptacle.

According to one embodiment, the first and second dispensing sub-systems are heterogeneous.

According to one embodiment, the bottle further comprises one or more of the following features:
the first dispensing sub-system is provided in the closure system;
the second dispensing sub-system is provided in the closure system;
the product dispensing system is provided in the closure system.

According to one embodiment, the product dispensing system is not suitable for an alternative dispensing of the product that may be contained in at least two receptacles.

According to one embodiment, the product dispensing system is suitable for an alternative dispensing of the product that may be contained in at least two receptacles.

According to one embodiment, the product dispensing system is suitable for alternatively dispensing either an alternative dispensing or a combined dispensing of the product that may be contained in at least two receptacles.

According to one embodiment, the at least two receptacles have at least one of the following features:
an identical external shape,
an external shape that is symmetrical to one another,
an external shape that is different from one another,
an external shape that is asymmetrical to one another,
an identical internal shape,
an internal shape that is symmetrical to one another,
an internal shape that is different from one another,
an internal shape that is asymmetrical to one another,
an identical volume plus or minus 10%,
a volume that differs by at least 10%,
a volume that differs by at least 50%,
identical external decoration,
different external decoration,
identical internal decoration,
different internal decoration.

According to one embodiment, the glass container body comprises a first container and a second container, the first container comprises a first assembly portion, the second container comprises a second assembly portion, the closure system comprises a first assembly portion and a second assembly portion, the first assembly portion of the first container is hermetically assembled to the first assembly portion of the closure system so as to define the first receptacle, and the second assembly portion of the second container is hermetically assembled to the second assembly portion of the closure system so as to define the second receptacle.

According to one embodiment, the bottle comprises a bearing surface, the bottle being intended to be placed with its bearing surface resting on a support during normal use of the bottle.

According to one embodiment, during normal use, at least one receptacle is defined by a lower portion that is part of the glass container and by an upper portion that is part of the closure system.

According to one embodiment, the receptacles are side by side.

According to one embodiment, the receptacles are nested one inside the other.

According to one embodiment, during normal use, at least one of the receptacles has an elongated shape along the vertical direction.

According to one embodiment, the first and second receptacles are assembled together permanently.

According to one embodiment, the dispensing system enables dispensing the product through a first dispensing hole, the glass container body comprising a mouth hermetically assembled to the closure system to form the first receptacle, the cross-sectional area of the mouth being at least twice that of the first dispensing hole.

According to one embodiment, the bottle comprises a solid object inside the first receptacle, the object being of dimensions between the cross-sectional dimensions of the mouth and those of the first dispensing hole.

According to one embodiment, the object is assembled to the closure system.

According to one embodiment, the single glass container body comprises at least one mouth, the closure system defines a first dispensing through-hole, the dispensing system enables dispensing product through the first dispensing hole, the glass container body comprising a mouth hermetically assembled to the closure system to form the first receptacle, the cross-sectional area of the mouth being at least twice that of the first dispensing hole.

According to one embodiment, the closure system comprises a sealing part and a locking part, the sealing part comprises a cover for closing the mouth and a system for assembly to a product dispensing system, the cover comprises a sealing portion and a neck extending axially upward from the sealing portion, and the neck defines the first dispensing through-hole.

According to one embodiment, the neck extends axially upward from the sealing portion.

According to one embodiment, the dispensing system enables dispensing product through a first dispensing hole, the glass container body comprising a mouth hermetically assembled to the closure system to form the first receptacle, the shape of the cross-section of the radially inner surface of the glass container body at the mouth being non-circular.

According to another aspect, the invention relates to a system comprising such a bottle and a first product and a second product each contained in a respective one of the two receptacles.

According to one embodiment, the first and second products differ in at least one of the following characteristics:
chemical composition,
density,
dilution factor,
viscosity.

According to another aspect, the invention relates to a method for producing a bottle, comprising:
the production of a glass container system comprising a single glass container body,
the hermetic and permanent assembly of a closure system to the glass container system, the glass container system and the closure system being assembled to one another so as to define at least first and second separate receptacles that are sealed in relation to one another,
   a product dispensing system enabling discharging from the bottle the product that may be contained in the receptacles.

According to one embodiment, the glass container body is produced by pressing.

According to one embodiment, two containers are produced in the glass container body by implementing a pressing step.

According to one embodiment, two containers are produced in the glass container body by implementing a simultaneous pressing step.

According to one embodiment, the closure system is assembled to the glass container system so as to define the receptacles simultaneously.

The figures in the drawings are now briefly described.

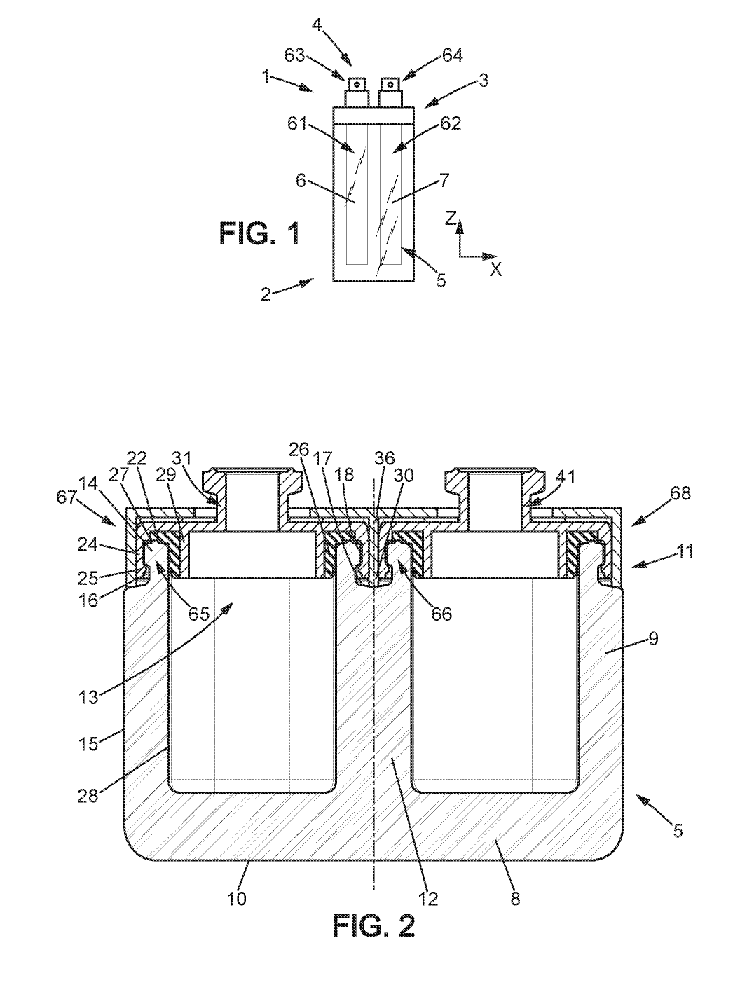

FIG. 1 is a diagram corresponding to a front view of a bottle according to a first embodiment.

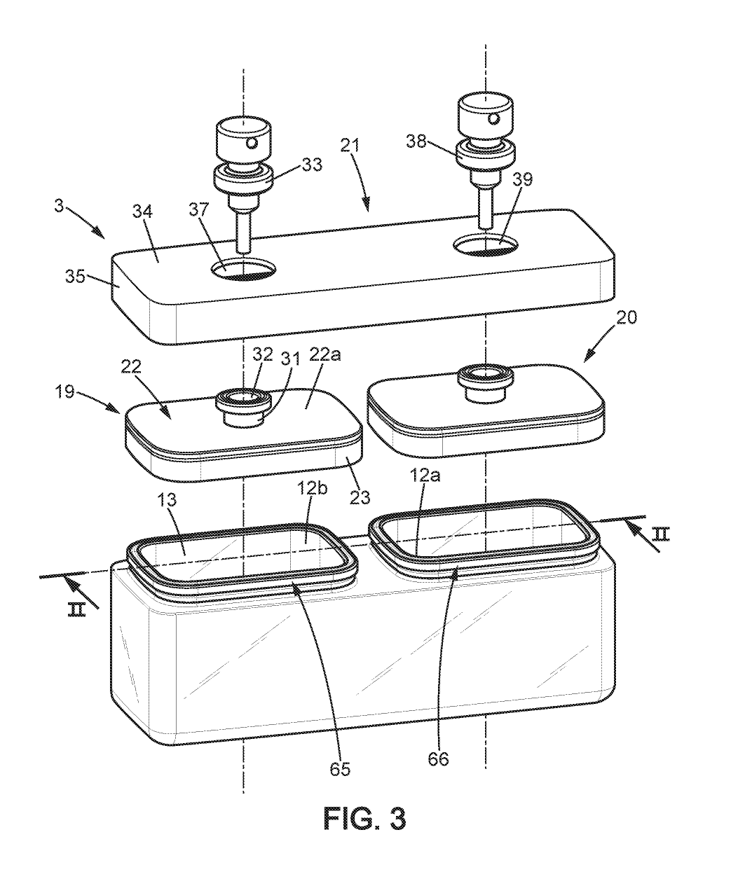

FIG. 2 is a detailed sectional view of the embodiment of FIG. 1, along line II-II in FIG. 3.

FIG. 3 is a perspective view of the embodiment of FIG. 1.

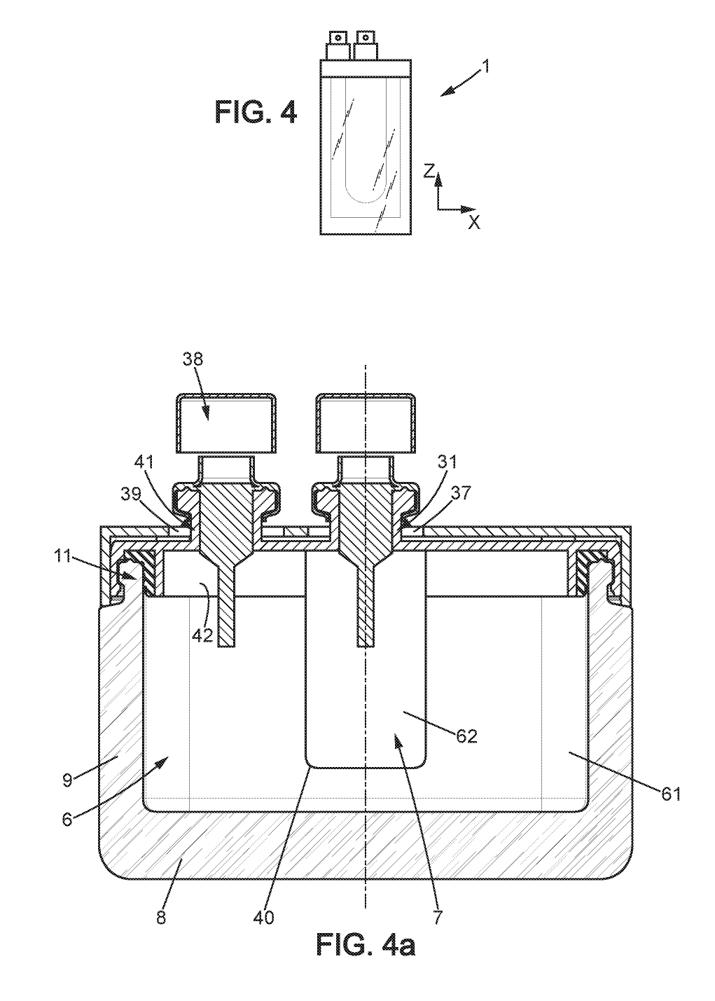

FIG. 4 is a diagrammatic view similar to FIG. 1 for a second embodiment of the invention.

FIG. 4a is a sectional view similar to FIG. 2 for the second embodiment.

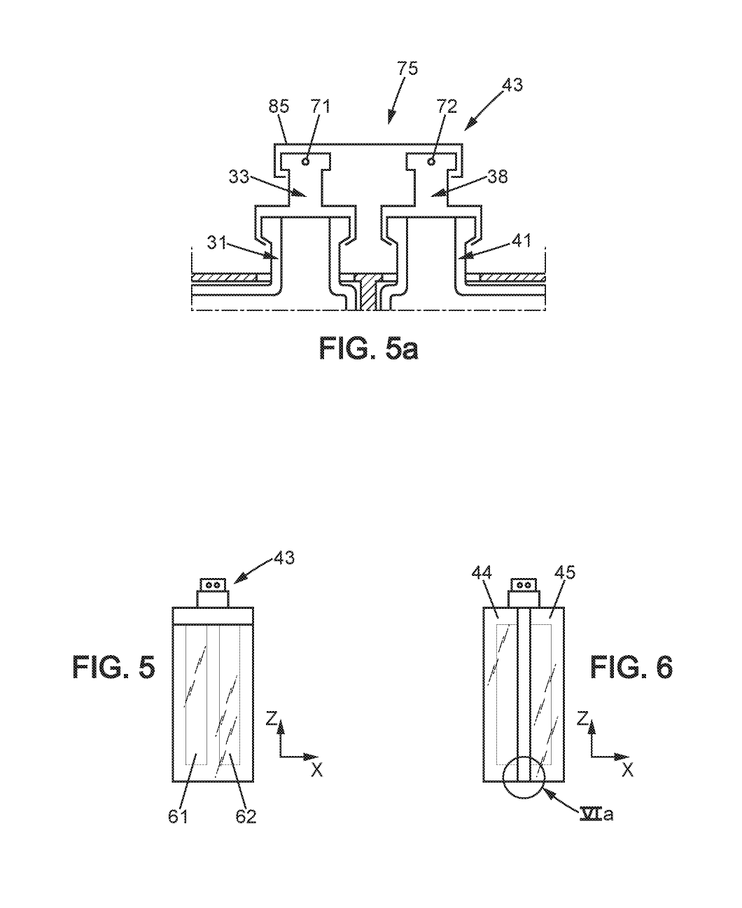

FIG. 5 is a diagrammatic view similar to FIG. 1 for a third embodiment of the invention.

FIG. 5a is a detailed diagrammatic view for an example implementation of the dispensing system of the bottle of FIG. 5.

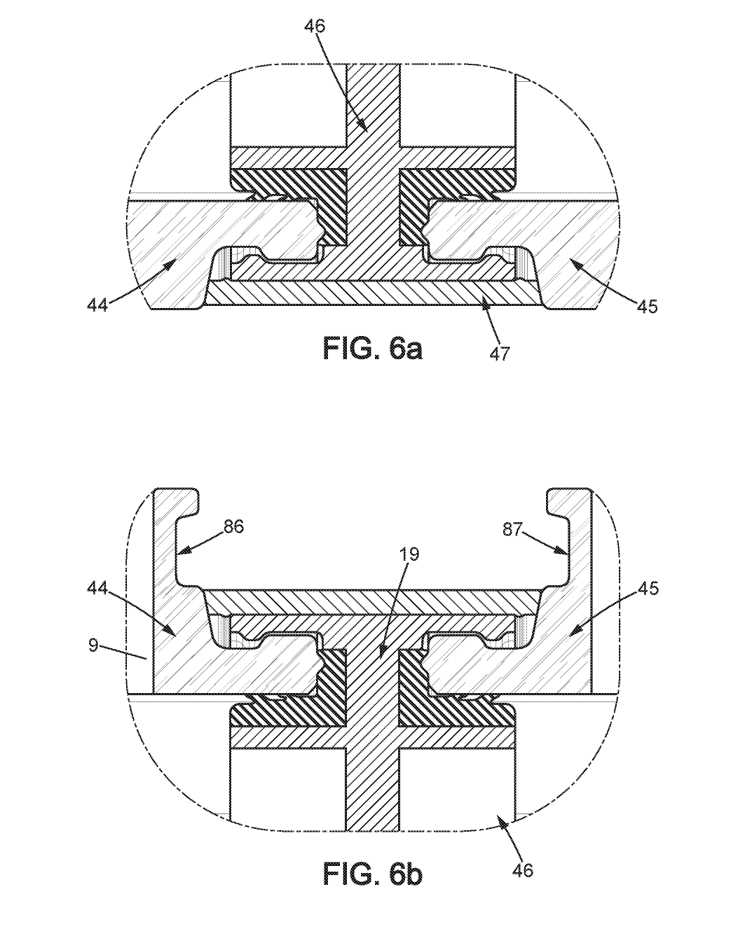

FIG. 6 is a diagrammatic view similar to FIG. 1 for a first comparative example.

FIG. 6a is a detailed sectional view of the embodiment of FIG. 6, of the area referenced VIa in FIG. 6.

FIG. 6b is a detailed sectional view of the embodiment of FIG. 6, at the dispensing system.

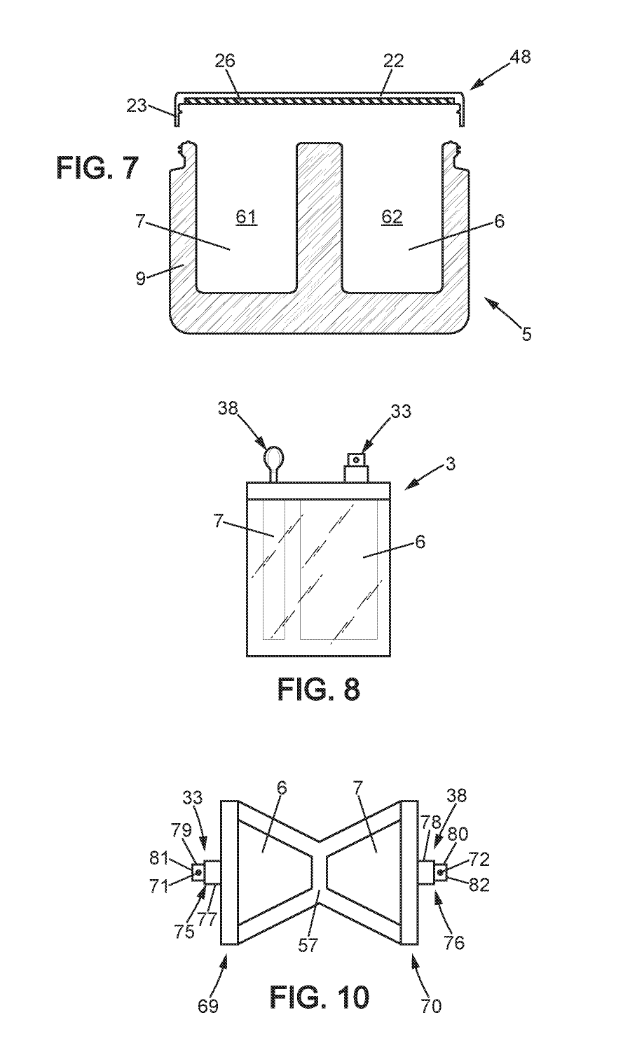

FIG. 7 is an exploded sectional view for a second comparative example.

FIG. 8 is a diagrammatic view similar to FIG. 1 for a fourth embodiment of the invention.

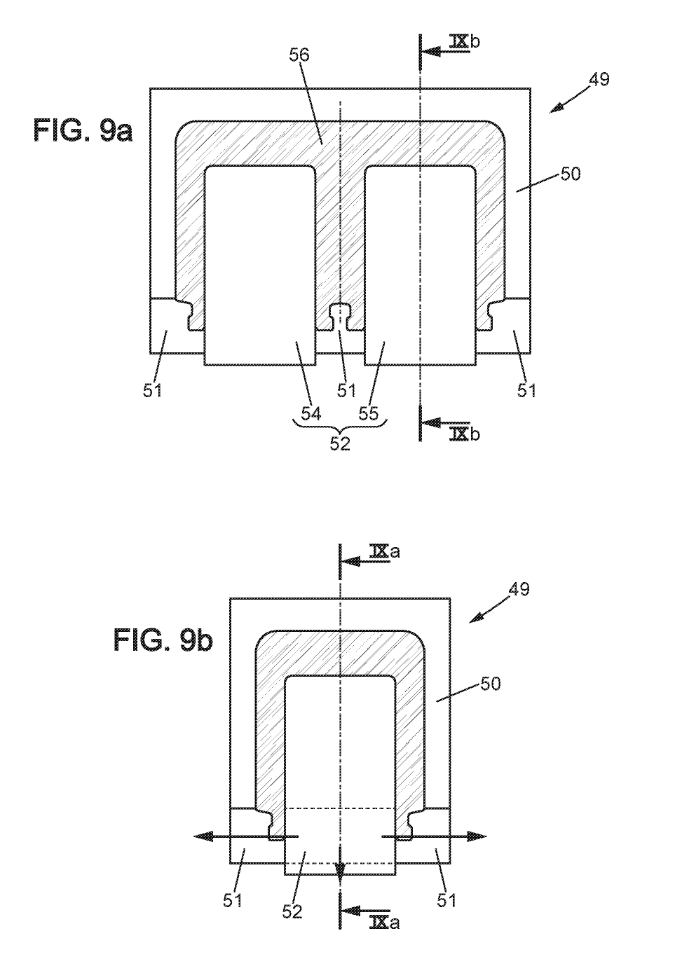

FIG. 9a is a diagrammatic view of a method for producing a glass container system for the embodiment of FIG. 1, showing a cross-section along plane IXa-IXa visible in FIG. 9b.

FIG. 9b is a diagrammatic view similar to FIG. 9a, showing a cross-section along plane IXb-IXb visible in FIG. 9a.

FIG. 10 is a diagrammatic front view for a fifth embodiment of the invention.

FIGS. 12a and 12b are functional diagrams of an exemplary dispensing member in two distinct configurations.

FIG. 13 is a diagrammatic view similar to FIG. 1 for a third comparative example.

In the various figures, the same references designate identical or similar elements.

Below is a detailed description of several embodiments of the invention, accompanied by examples and with reference to the drawings.

FIG. 1 is a schematic representation of a bottle 1 according to a first embodiment of the invention. The bottle 1 is represented in a position where it is stably resting on a flat support (not shown). The flat support may define two axes X, Y, the vertical axis Z being orthogonal to this plane. The bottle 1 comprises a glass container system 2 and a closure system 3. In the example shown, the closure system 3 is hermetically assembled to the glass container system 2. This hermetic assembly means the fluid product contained in the bottle cannot flow out of the bottle at the connection between the glass container system 2 and the closure system 3 under normal conditions of use of the bottle 1, including conditions in which the bottle 1 is in any orientation different than the one in FIG. 1. The degree of hermetic seal may be defined by a leak test. Such a leak test may, for example, include placing the filled bottle in a vacuum chamber, in a predetermined orientation, for example with content in contact with the potential leakage area of the bottle. The ambient pressure in the chamber will gradually drop at a predetermined rate, the degree of sealing being defined by the ambient pressure at which the content begins to leak from the bottle. Some embodiments disclosed herein may achieve a degree of sealing of −800 millibar (mbar) or even −950 mbar relative to atmospheric pressure.

In the embodiment shown, the glass container system 2 and the closure system 3 are assembled together permanently. “Permanently” is understood to mean that the closure system 3 cannot be disassembled from the glass container system 2 under normal conditions of use. Of course, a user cannot be prevented from detaching the two systems if he or she applies the force necessary to do so, but this falls outside the normal use of the container.

The glass container system 2 is made primarily of glass. Any type of glass compatible with the intended application may be used, including the types already currently in use in the bottle industry.

A dispensing system 4 is provided to enable dispensing from the bottle a product contained in the bottle 1. Here any dispensing system 4 may be used that is appropriate for the product contained in the bottle 1.

In the embodiment shown, the glass container system 2 comprises a glass container body 5. In the example shown, the glass container body 5 is created as one piece. The glass container body 5 comprises a first container 6 and a second container 7. The first and second containers 6, 7 are separate. Two containers are said to be separate when, in the position of the container body 5 as shown in FIG. 1, a fluid product contained in a first container cannot flow into the second container and vice versa.

As can be seen in particular in FIG. 2, the glass container body 5 comprises a bottom 8 from which extends a peripheral wall 9. The bottom 8 has a lower external bearing surface 10 which can be placed on the flat support, the container body 5 and/or the bottle 1 then resting stably.

The peripheral wall 9 extends from the bottom 8 to an upper portion 11 at a certain height. In the example shown, the upper portion 11 is used for assembly of the glass container body 5 to the closure system 3. The glass container body 5 also comprises an intermediate wall 12 defining the first and second receptacles 6, 7. The intermediate wall 12 is formed integrally with the peripheral wall 9 and extends from side to side, from a first end 12a connected to the peripheral wall 9 to a second end 12b connected to the peripheral wall 9, substantially along its full height.

An exemplary embodiment of a sealed assembly between the glass container body 5 and the closure system 3 will be given below with reference to FIGS. 2 and 3. In practice, each container 6, 7 is hermetically assembled to the closure system 3. The example shown includes the YZ plane as the plane of symmetry. Also, a description will be given only for the sealed assembly of the first container 6, the sealed assembly of the second container 7 being deduced from this by symmetry. The invention is not limited to this symmetrical embodiment, however. The first container 6 comprises a mouth 13. The mouth 13 is defined in part by the peripheral wall 9, and in part by the intermediate wall 12. The peripheral wall 9 and the intermediate wall 12 join together to surround the mouth 13. In its upper portion 11, the peripheral wall 9 comprises a contoured section. This contoured section is particularly visible in FIG. 2. An identical or similar contour extends along the periphery of the upper portion 11 of the peripheral wall 9 at the mouth 13. In particular, this contour comprises a bead 14 extending radially outward. The bead 14 is radially further inward than the outer surface 15 of the peripheral wall 9. A recess 16 can thus be found between the outer surface 15 and the bead 14.

A groove 17 is formed in the upper portion of the intermediate wall 12, from one to the other of the ends 12a, 12b. The groove 17 is defined by an assembly surface 18 substantially opposite to the bead 14.

The closure system 3 comprises a sealing part 19, 20 that is independent for each container 6, 7, and a locking part 21. Sealing part 20 is implemented similarly to sealing part 19, in the current case symmetrically relative to plane YZ, and therefore will not be further described here. Sealing part 19 has an elastically deformable portion for clip-on assembly to the glass container body 5. In particular, the bead 14, the recess 16, and the assembly surface 18, all formed so as to be integral to each other, define an assembly interface for the first container 6. The sealing part 19 has an assembly portion of a geometry complementary to the assembly interface for the first container 6. In particular, the sealing part 19 may comprise a cover 22 of an appropriate geometry for closing the mouth 13, and a peripheral skirt 23 extending from the cover 22 in the direction of the first container 6, and adapted for clip-on assembly to it. For example, the cross-section of the peripheral skirt 23 may comprise an elastically deformable arm 24 at the end of which is located a bead 25 that projects radially inward. The arm 24 is adapted to be elastically deformed during assembly of the sealing part 19 to the glass container body 5, until the bead 25 is received in the recess 16.

In the example presented, the sealing part 19 may also comprise a gasket 26. The gasket 26 extends continuously and peripherally around the mouth 13. The gasket 26 is supported by the cover 22. In the exemplary embodiment shown, it covers the entire upper surface 27 of the first container 6. Purely as an illustration, the gasket 26 may have an L-shaped cross-section, as represented in FIG. 2, with a horizontal first portion engaging with the upper surface 27 of the first container 6 and a second vertical portion, continuous with the first horizontal portion, and engaging with the radially inner surface 28 of the first container 6. The cover 22 may also comprise a surface facing radially outward 29, towards the arm 24, and serving as a seat for the vertical second portion of the gasket 26. This surface facing radially outward 29 serves as a seat for the vertical second portion of the gasket 26 so that it is compressed between the cover 22 and the first container 6.

Various shapes and configurations of the gasket may be provided. For example, the two portions of the L are not completely joined along the periphery of the gasket, or may not be joined at all. Aside from the L-shape described above, a U-shape may be provided for example, comprising the L-shape described above plus an additional portion extending from the first portion, parallel to the second portion, and applied between the arm 24 and the bead 14. Where appropriate, an L-shape may alternatively be provided, defined starting from the U-shape just described, but without the second portion. In this last embodiment, the closure part 19 of the portion providing the surface 29 may be eliminated. Alternatively, the gasket 26 may have a substantially triangular cross-section so that one face of said gasket is compressed against an edge of the glass container body 5 formed between the side surface and the outer face of the bead.

According to one embodiment of the invention, the gasket 26 comprises at least one protruding element or sealing lip adapted to form a sealing line against the surface of the container body 5. Preferably, the at least one sealing lip has a tapered shape or has an outer surface with a partially circular cross-section.

In the example, the gasket 26 comprises two sealing lips (as shown), each capable of forming a sealing line against the inner face 28 of the container body 5.

A number of upper sealing lips greater than two may also be considered, particularly when the gasket 26 is configured so that each forms a sealed connection between the closure part 19 and only one among the surfaces of the container body 5.

When at least two sealing lips are used, they may, depending on the configuration of the gasket 26, be arranged so that each forms a sealing line against multiple surfaces of the container body 5.

Alternatively, the closure part 19 and the gasket 26 are one part and are formed of the same material. This applies in particular to the case of polyethylene, or high density polyethylene. The characteristics of the gasket 26 and the embodiments detailed above can be adapted to the closure part 19 alone.

The components likely to be in contact with the content (in particular the closure part 19 and the gasket 26) are chosen to meet requirements of compatibility (the product to be contained in the bottle does not cause deterioration of the component) and neutrality (the component does not release any compounds into the liquid product in undesirable proportions). These requirements affect the materials used for these components or their production method. The requirements may depend on the content.

As can be seen in particular in FIG. 2, when the sealing part 19 is assembled to the first container 6, the arm 24, at the mating surface 18, extends away from the plane of symmetry YZ. A slot 30 is therefore provided between the arm 24 of sealing part 19 and the one opposite sealing part 20, arranged in the groove 17.

In the embodiment shown, the sealing part 19 also comprises a system for assembly to a product dispensing system for the product that may be contained in the first container 6. In the example shown, the cover 22 has a sealing portion 22a and a neck 31 extending axially upward from the sealing portion 22a of the cover 22. The neck 31 defines a through-hole 32 by means of which the product that may be contained in the first container 6 can flow through the sealing part 19. The through-hole 32 is small in size relative to the mouth 13. Small in size is understood to mean that the cross-sectional area of the through-hole is smaller, at the macroscopic scale, than the cross-sectional area of the mouth 13, for example at least twice or even at least five times smaller. Furthermore, the sectional shape of the through-hole 32 is independent of the sectional shape of the mouth 13.

The mouth 13 may have any cross-sectional shape that can be manufactured. The through-hole 32 will have a shape complementary to a dispensing member 33 to be assembled to it. In particular, the cross-section of the through-hole 32 may have a substantially annular shape that is rotationally symmetrical.

When mention is made of the sectional shape of the mouth 13, this refers in particular to the sectional shape of the radially inner surface 28 of the first container 6 at the mouth 13, given that the external shape at the mouth 13 is functionally dictated by that of the radially inner surface 28, and given the functional need for a sealed assembly. As for the sectional shape of the radially inner surface 28 of the first container 6 at the mouth 13, this may be any suitable shape, such as a polygonal shape with rounded edges, oval, ellipsoid, and in particular any non-circular shape that can be manufactured. For a non-circular shape, the skilled person knows the level of regularity to expect in a surface formed during a glass pressing process. A non-circular shape is considered to be such from the moment a skilled person is able to determine, when observing the shape, that it was deliberately manufactured to be non-circular. Thus, non-circular does not cover circular shapes in which shape defects due to the production method have changed the shape relative to a desired ideal geometric circle. For example, a non-circular shape will be considered to be such when there is a deviation of more than 2% between the nominal diameter of a surface in question and the diameters inscribed and circumscribed on the surface in question. A difference of more than 20% is quite possible. The shape in question is that of the inner surface, and/or the outer surface, independently of any protruding contours serving as catches, such as the bead 14.

FIGS. 2 and 3 also show the locking part 21. In the example shown, a single locking part 21 may be provided for example, capable of engaging with each of the sealing parts 19,20. The locking part 21 may be made of a rigid material which can clasp the sealing parts 19,20 to restrict any macroscopic elastic deformation over time. For the locking part 21, a single part may be provided for example, comprising a cover 34 from which extends a peripheral skirt 35. In an intermediate portion of the locking part 21, a continuous projection 36 is provided between two opposite edges of the peripheral skirt 35, parallel to the groove 17, suitable for insertion into the slot 30 in order to hold the arm 24 tightly against the assembly surface 18 of the first container 6. The cover 34 also has a through-hole 37 through which the neck 31 of the closure part 19 extends.

The embodiment just described can be assembled in the following manner. To begin, a glass container body 5 as described above is provided.

The closure system 3 is assembled to the glass container body 5. To begin, sealing part 19 is clipped to the first container 6, and sealing part 20 is clipped to the second container 7. Then the sealing parts 19 and 20 are clasped onto the glass container body 5 by the locking part 21. The necks 31 extend through its holes 37 and 39. Next, the first container 6 is filled with a first product to be dispensed, introducing it through the neck 31 of sealing part 19. This product is thus in direct contact with the glass container body 5 and sealing part 19. The second container 7 is filled with a second product to be dispensed, introducing it through the neck 31 of sealing part 20. This product is thus in direct contact with the glass container body and sealing part 20. A product to be dispensed may itself contain a mixture of multiple chemical compounds, but of a composition in the bottle, for example homogeneous, that has been appropriately verified for the intended application. The two products to be dispensed may differ from one another in one or more characteristics, such as chemical composition, density, dilution factor, viscosity, etc. Next, a dispensing member 33 is assembled onto the neck 31 through the hole 37 in any known manner, and adjusted to the neck 31, which in the example shown may be made of plastic, for example by crimping, snap-fitting, screwing, or any other appropriate method. The dispensing member 33 may comprise a dip tube providing access to the product in the bottom of the first container 6. To assemble a dispensing member 38 onto the neck of sealing part 20 through through-hole 39 of the locking part 21, one may proceed in the same manner. The dispensing member 38 may comprise a dip tube providing access to the product contained in the bottom of the second container 7.

In this assembled configuration, two integral receptacles 61, 62 which are sealed relative to one another each respectively contain a product to be dispensed. Each receptacle is formed by a respective container 6, 7 and a portion of the assembly system 3 which engages therewith. Thus, “receptacle” is understood to mean a closed volume able to contain a product and accessible only via the dispensing system 4. Here, during normal use, at least one receptacle 61, 62, and in particular each receptacle, is delimited by a lower portion that is part of the glass container and an upper portion that is part of the closure system.

The glass container body thus comprises a first container 6 and a second container 7, the first container comprises a first assembly portion 65 (here its upper portion), the second container comprises a second assembly portion 66 (here its upper portion), the closure system comprises a first assembly portion 67 (here implemented by the locking part 21 clasping the first closure part 19) and a second assembly portion 68 (here implemented by the locking part 21 clasping the second closure part 20). The first assembly portion 65 of the first container 6 is hermetically assembled to the first assembly portion 67 of the closure system 3 so as to define the first receptacle 61, and the second assembly portion 66 of the second container 7 is hermetically assembled to the second assembly portion 68 of the closure system 3 so as to define the second receptacle 62.

The first dispensing member 33 and the second dispensing member 38 together constitute the dispensing system 4. The dispensing system 4 allows the user to dispense either the first or the second product contained in the bottle 1.

Thus, the dispensing system comprises a first dispensing sub-system 63 for discharging product that may be contained in the first receptacle, and a second dispensing sub-system 64 for discharging product that may be contained in the second receptacle. The first product is dispensed through a dispensing hole of the closure system, which in this case is through-hole 32. The second product is dispensed through a dispensing hole of the closure system, which in this case is through-hole 42.

As can be seen in FIG. 12a, the first dispensing sub-system comprises a first product outlet 71, a first tube 73 adapted to guide the product which may be contained in the first receptacle to the first product outlet 71, and a first actuating member 75 operable by a user to control the output of product through the first product outlet 71. The first actuating member 75 comprises a base 77 fixed to the closure system, and a member 79 that is movable relative to the base and comprising an actuation region 81 accessible to a user which can be actuated to control the release of first product, the movable member 79 providing the first product outlet 71. In the present example, this description also applies to the second dispensing sub-system.

The movable member 79 is, for example, movable with respect to the base 77 with a degree of freedom allowing it to slide, as can be seen by comparing FIGS. 12a and 12b, in order to discharge product when actuated by a user.

The embodiment of a pump implemented in this type of bottle, described very briefly above, can be modified in various ways accessible to persons skilled in the field of pumps for bottles, without affecting the invention.

This embodiment finds application in cosmetics, for example, enabling a user to dispense one or the other of the two products contained in a bottle, as desired.

According to the embodiment described above, the two receptacles are side by side. They extend substantially vertically in the nominal rest position of the bottle.

According to a second embodiment, as shown in FIG. 4, the two containers may be nested one inside the other.

According to the embodiment shown, the glass container body 5 comprises a single container 6. The second container 7 is not provided by the glass container body 5.

As can be seen in particular in FIG. 4a, the glass container body 5 comprises a bottom 8 from which extends a peripheral wall 9.

The peripheral wall 9 extends from the bottom 8 to the upper portion 11. In the example shown, the upper portion 11 is used for assembling the glass container body 5 to the closure system 3.

An exemplary embodiment of a sealed assembly between the glass container body 5 and the closure system 3 will be given below with reference to FIG. 4a. The first container 6 comprises a mouth 13. The mouth 13 is defined by the peripheral wall 9. The peripheral wall 9 surrounds the mouth 13. In its upper portion 11, the peripheral wall 9 comprises a contoured section. This contoured section is particularly visible in FIG. 4a. An identical or similar contour extends along the periphery of the upper portion 11 of the peripheral wall 9 at the mouth 13. In particular, this contour comprises a bead 14 extending radially outward. The bead 14 is radially further inward than the outer surface 15 of the peripheral wall 9. A recess 16 can thus be found between the outer surface 15 and the bead 14.

The closure system 3 comprises the sealing part 19 and a locking part 21. The sealing part 19 has an elastically deformable portion for clip-on assembly to the glass container body 5. In particular, the bead 14 and the recess 16 define an assembly interface for the container 6. The sealing part 19 has an assembly portion of a geometry complementary to the assembly interface for the first container 6. In particular, the sealing part 19 may comprise a cover 22 of an appropriate geometry for closing the mouth 13, and a peripheral skirt 23 extending from the cover 22 in the direction of the first container 6, and adapted for clip-on assembly to it. For example, the cross-section of the peripheral skirt 23 may comprise an elastically deformable arm 24 at the end of which is located a bead 25 that projects radially inward. The arm 24 is adapted to be elastically deformed during assembly of the sealing part 19 to the glass container body 5, until the bead 25 is received in the recess 16.

In the example presented, the sealing part 19 may also comprise a gasket 26 similar to the one described above.

A second container 7 is provided by means of a casing 40 which can be assembled to the sealing part 19. The casing 40 may be of any suitable shape or composition, but will generally have a volume that fits within the volume defined by the first container 6. The casing 40 may, for example, be made using a flexible bag, for example of plastic, hermetically assembled to the sealing part 19. In particular, the casing 40 may be assembled to the lower face of the cover 22. A sealed peripheral connection is provided, for example by ultrasonic welding, heat sealing, or bonding, in the same manner as a lid is welded to the peripheral edge of a plastic pot for example. Alternatively, the casing 40 may be made of another material (glass, metal, etc.) and assembled by any appropriate means to the sealing part 19. The assembly of the casing 40 and the cover 22 forms the second receptacle 62. The assembly of the closure system 3 supporting the casing 40 and the glass container body 5 forms the first receptacle 61.

In the embodiment shown, the sealing part 19 also comprises a system for assembly to a product dispensing system for a product that may be contained in the first container 6 and a system for assembly to a product dispensing system for a product that may be contained in the second container 7. In the example shown, the cover 22 has two necks 31, 41 extending axially upward from the cover 22 and laterally offset relative to one another. Each neck 31, 41 defines a respective through-hole 32, 42 by which the product that may being contained in the second container and the first container 7 and 6, respectively, can flow through the sealing part 19. Thus, through-hole 32 leads to inside the casing 40, and through-hole 42 leads to outside the casing 40 but inside the mouth 13. The through-hole 32, 42 will have a shape complementary to a dispensing member 33, 38 to be assembled to it.

FIG. 4a also shows the locking part 21. In the example shown, it is possible for example to provide a locking part 21 that engages with the sealing part 19. The locking part 21 may be made of a rigid material capable of clasping the sealing part 19 to restrict any macroscopic elastic deformation thereof over time. For the locking part 21, there may be provided for example a single part comprising a cover 34 from which extends a peripheral skirt 35. The cover 34 also has two through-holes 37, 39, through which the necks 31, 41 of the closure part 19 respectively extend.

The embodiment just described may be assembled in the following manner. To begin, a glass container body 5 as described above is provided. Also provided is a sealing part 19 equipped with a casing 40 defining a second container.

The closure system 3 is assembled to the glass container body 5. To begin, sealing part 19 is clipped onto the first container 6. Next, sealing part 19 is clasped onto the glass container body 5 by the locking part 21. The first container 6 is filled with a first product to be dispensed. The second container 7 is filled with a second product to be dispensed. These two steps take place in any suitable order, sequentially or simultaneously. The two dispensed products may differ from one another in one or more of a number of characteristics, such as chemical composition (nature or proportion of the components), density, dilution factor, viscosity, etc. Next, dispensing member 33 is assembled onto neck 31 through hole 37 in any known manner, as described above. One can proceed in the same manner to assemble dispensing member 38 onto the neck of sealing part 20 via through-hole 39 of the locking part 21.

In this assembled configuration, two integral receptacles 61, 62 which are sealed relative to one another each respectively contain a product to be dispensed. A receptacle 62 is formed by container 7 assembled to the cover 22. Another receptacle 61 is formed by the complement of this receptacle within container 6, reaching the volume defined by the glass container body and the assembly system 3 engaging with it.

Here, one receptacle is defined by a lower portion that is part of the glass container and by an upper portion that is part of the closure system. The other receptacle is defined by a casing, not necessarily of glass, hermetically assembled to the closure system.

The first dispensing member 33 and a second dispensing member 38 together form the dispensing system 4. The dispensing system 4 allows the user to dispense either the first or the second product contained in the bottle 1.

FIG. 5 shows a third embodiment. In this embodiment, the glass container body is designed similarly to the first embodiment. The dispensing system comprises a single dispensing member 43 which allows simultaneously dispensing the products that may be contained in the two receptacles 61, 62.

One possible embodiment is shown in FIG. 5a. In particular, starting from the embodiment described in FIG. 2, the necks 31 and 41 are brought as close as possible to one another, and the two dispensing members 33, 38, each respectively associated with one of the necks, are covered with a common cap 85. User actuation of the common cap 85 simultaneously actuates the two dispensing members 33, 38. User actuation of the common cap 85 prohibits independent actuation of the two dispensing members 33, 38.

In this example, a single actuating member 75 is used, consisting of the common cap 85 in this case, of which the movable member 79 provides the first and second product outlets 71, 72.

Such an embodiment finds application for example in cosmetics, for simultaneously dispensing two products that cannot be stored for very long in a mixed state. The mixture is thus made at the time the products are dispensed.

According to a first comparative example which does not correspond to the invention as initially claimed, as shown in FIG. 6, the glass container system 2 comprises two separate glass container bodies 44, 45. For example, two glass container bodies 44, 45 are used that are symmetrical to one another relative to plane Y-Z. It is not necessarily required to have two bodies that are symmetrical to one another. However, to simplify this description, we will refer to such an example.

In this embodiment, use is made of a single sealing part 46 engaging with each of the glass container bodies 44, 45. The form of the sealing part of the first embodiment is used, except that a cover is provided that has no through-hole 32. This part is symmetrically duplicated relative to plane Y-Z in FIG. 6, the symmetrical part being integral with the original part by their respective covers 22 which then form a central web. The sealing part 46 obtained in this manner is assembled independently to each glass container body 44, 45 in the manner previously described for the second embodiment. This forms a first container 6 defined by a first glass container body 44 and the closure system 3 assembled thereto, and a second container 7 defined by a second glass container body 45 and the closure system 3 assembled thereto.

The associated locking part 47 may comprise a rigid ring, for example of metal, which will encircle the outer surface of the sealing part 46. An open ring may be provided for example, which will be placed around the sealing part and tightened until a satisfactory position is achieved where the two free end portions of the ring are now integral.

For the dispensing system 4, several variants are possible. A first variant is represented in FIG. 6b. The dispensing system 4 is assembled directly onto the glass container body. One proceeds for example in a known manner for assembling a dispensing member to a glass container. The first glass container body 44 comprises neck 86 which is created as a glass neck is typically created on a glass container body. Neck 86 is formed in a peripheral wall 9 of the first glass container body. Dispensing member 33 is assembled onto neck 86 in an appropriate manner, as desribed above. One can proceed in the same manner for the second glass container 45, which has neck 87 onto which dispensing member 38 is assembled. For example, the same type of assembly is performed as for the assembly of the first dispensing member 33 onto the first glass container body 44. For example, the necks 86, 87 and consequently the dispensing members 33, 38 are provided so as to be symmetrical relative to the central plane of the bottle 1. If combined actuation of the two dispensing members 33, 38 is provided, a common cap may be used as explained above in relation to FIG. 5a. Alternatively, independent actuation of the two dispensing members 33, 38 may be provided.

In a variant of the dispensing system 4 for the embodiment of FIG. 6, the necks are not necessarily created in the glass container bodies 44, 45, but in the sealing part 19 which is locally shaped for this purpose.

In the embodiments described above, a permanent assembly of the glass container system and the closure system was implemented. In a second comparative example which does not correspond to the invention as initially claimed, a removable assembly could be provided. In one exemplary embodiment, represented in FIG. 7, a glass container body 5 is provided for example as described above in relation to FIG. 2, except as it regards the assembly interface to the closure system. An assembly interface is provided which enables a detachable assembly between the glass container body 5 and the closure system 3.

The closure system 3 may include a cap 48 comprising a cover 22 and a skirt 23. The skirt 23 provides the system for assembly to the glass container body 5. A functional example of an assembly system may include a thread and a corresponding tapping, formed in the skirt 23 and the outer surface of the glass container body 5. The outer surface of the glass container body 5 providing the assembly interface may then be of circular shape.

The lower face of the cover 22 may comprise a gasket 26 for sealing the two containers 6, 7 relative to one another when the closure system and the glass container body are connected together. The gasket 26 extends to the peripheral wall 9, so that it also seals each of the containers relative to the outside in this configuration. This forms a first receptacle 61 defined by the first container 6 and the closure system 3, and a second receptacle 62 defined by the second container 7 and the closure system 3.

In this comparative example, the dispensing system is simply implemented by placing the cover in the open configuration, which provides access to the two products held in the containers 6 and 7.

To simplify the examples presented above, containers 6 and 7 were presented as being very similar. Very similar dispensing systems are also represented.

Alternatively, however, containers 6 and 7 may be quite different, and/or the dispensing systems may be heterogeneous.

Thus, depending on the examples, at least two receptacles have one or more (if they are compatible) of the following features:
an identical external shape,
an external shape that is symmetrical to one another,
an external shape that is different from one another,
an external shape that is asymmetrical to one another,
an identical internal shape,
an internal shape that is symmetrical to one another.
an internal shape that is different from one another,
an internal shape that is asymmetrical to one another,
an identical volume plus or minus 10%,
a volume that differs by at least 10%,
a volume that differs by at least 50%,
identical external decoration,
different external decoration,
identical internal decoration,
different internal decoration.

An example is shown in FIG. 8 of a glass container body comprising two containers 6, 7 of very different shape and volume. In such a case, heterogeneous dispensing members each associated with one of the containers may be provided. For example, for the container of large volume, a dispensing member such as a pump may be provided, adapted to dispense a large volume of product at each actuation. For the container of small volume, a dispensing member such as an applicator may be provided, adapted to dispense a small volume of product at each actuation. Such a system may be of interest for example in cosmetics, when the two products are different. The user can then create her own perfume, to suit the preferences of the moment, by dispensing the two components independently and as desired. Alternatively, the two containers may contain two complementary products, a first product held in container 6 for application over a large area, and a second product held in container 7 for local application. The second product is, for example, more concentrated than the first product.

The first product is toilet water, for example, and the second product is perfume. Alternatively, the products are intended to be used for different occasions. One product may be provided for day use for example, and one product for night use (case applicable to skincare products, for example). In another variant, the two containers hold the same product, and the container of small volume will be used to test the application of the product. If the test is satisfactory, the product can be applied from the large container.

Thus, depending on the variants, the dispensing members 33, 38 differ by one and/or both of:
the volume dispensed by the dispensing,
the dispensing mode, where “mode” refers to the dispensing technology, in particular spraying (application without contact - conveyed by gas) or application by contact of a liquid product (poured) or solid product (in this case, the application is by contact, using a brush, stick, spatula, etc.).

In the particular case of application by spraying, the spraying may also be characterized by different parameters, namely one or more of the following:
the type of dispensing, which concerns the ability to have the droplets spaced closer or further apart, or even to form a continuous jet,
the size distribution of the sprayed droplets,
the spatial three-dimensional shape of the dispensed volume (shape and cross-section of the cone of spray) between the bottle and the user.

In the particular case of application by contact, the contact may also be characterized by different parameters, namely one or more of the following:
the type of dispensing, according to whether the product is applied by pouring or with an applicator, and in the latter case the type of applicator (brush, stick, spatula, etc.)
the three-dimensional shape of the dispensed volume on the user (shape and cross-section of the pattern applied by the applicator).

FIGS. 9a and 9b schematically represent a method for producing a glass container body, in particular of the type used for the embodiment of FIG. 1. A mold 49 is used which comprises a lower portion 50 and an interface mold 51. It also uses a punching system 52 having the shape of the interior of the glass container body 5. in particular, for the exemplary embodiment, the punching system 52 comprises two individual punches 54, 55 for forming the containers 6 and 7. A gob of molten glass 56 is deformed between the punching system 52 and the mold 49. The molten glass 56 follows the contours of the space between the punch and the mold so as to form a glass item as represented in FIG. 1. In particular, the individual punches 54 and 55 pass through the interface mold 51 to form the assembly interface of the container body 5. The individual punches 54, 55 of the punching system cooperate with the lower mold portion to form the containers 6 and 7. As can be seen in particular in FIG. 9b, the interface mold 51 may be made of several independent portions that are movable transversely relative to the direction of displacement of the punching system, in particular in order to mold the groove 17.

The invention described above in several embodiments can be further presented in numerous variations. As can be seen for example in FIG. 10, the two containers 6, 7 are on opposite sides of a central web 57. The closure system 3 is divided into two independent closure sub-systems 69, 70, provided for each of the respective containers. The two dispensing members 33, 38 are therefore also independent.

The second dispensing sub-system 70 comprises a second product outlet 72, a second tube adapted to guide the product that may be contained in the second receptacle to the second product outlet 72, and a second actuating member 76 operable by a user to output product through the second product outlet 72. The second actuating member 76 comprises a base 78 fixed to the closure system, and a member 80 that is movable relative to the base and comprising an actuation region 82 accessible to a user, and which can be actuated to output the second product. The movable member 80 provides the second product outlet 72.

FIG. 13 shows an alternative embodiment of FIG. 6, for an independent dispensing of the two products. In this example, one will note that each glass body 44, 45 may be created with a conventional narrow glass neck onto which a dispensing member is assembled in a conventional manner.

Each receptacle may contain a large solid object. ‘Large’ is understood to mean that these objects have a size greater than the cross-section of the dispensing hole. For example, in FIG. 13, the first receptacle 61 contains a first decorative object 83 representing a flower, and the second receptacle contains a second decorative object 84 representing grass. These objects are possibly left free to move within their respective receptacle. Alternatively, the decorative object or objects are secured to (attached or made as an integral part of) the closure system 3. The closure system 3 comprises a seat for securing a decorative object. Having one or more receptacles contain a decorative object and/or having the closure system 3 comprise a seat for securing a decorative object does not apply only for the embodiment of FIG. 13 but for the other embodiments described as well, whenever possible.

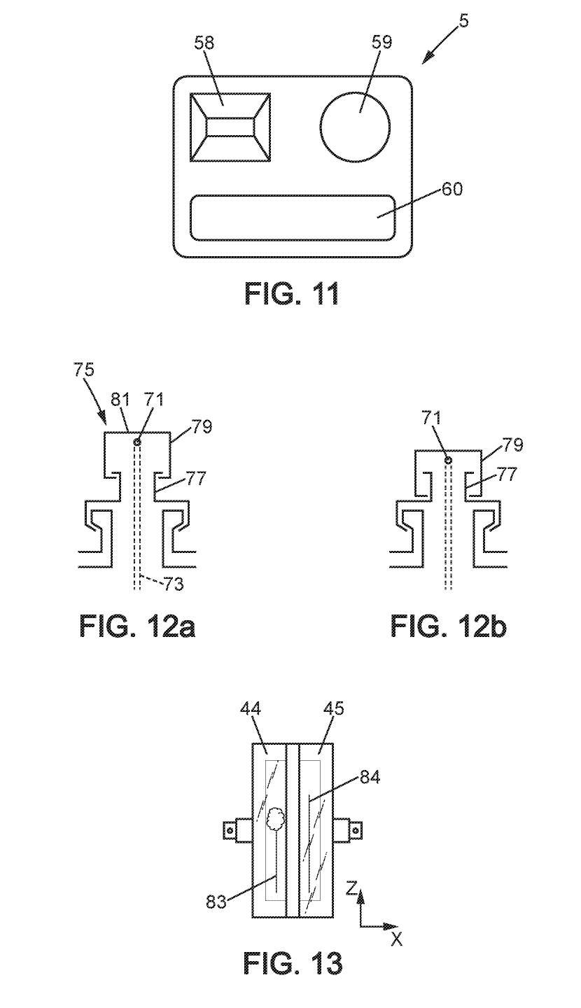

The invention is not limited to being used with only two receptacles. For example, three or more receptacles could be provided. The shapes of the receptacles may be varied, as long as they can be obtained by a direct press method or pressing-blowing method as mentioned above. FIG. 11 shows exemplary top views of a glass container body 5 comprising a first container 58 that is tapered with a square cross-section, a second container 59 that is cylindrical with a circular cross-section, and a third container 60 that is cylindrical with a rectangular cross-section having rounded edges.

The embodiments that implement the sealed closure of the glass container body or bodies presented above are illustrative only.

Although a dispensing system was represented above for embodiments having a combined dispensing of two products, comprising two product outlets 71, 72, alternatively a single product outlet connected to each of the receptacles could be provided.

A second invention relates to a bottle comprising:
a glass container system 2 comprising at least two glass container bodies 5,
a closure system 3 hermetically assembled to the glass container system 2, the glass container system 2 and the closure system 3 being assembled to each other so as to define at least first and second separate receptacles 61, 62 that are sealed in relation to one another,
a product dispensing system 4 for discharging from the bottle the product that may be contained in the receptacles 61, 62.

In various aspects of this second invention, one or more of the following arrangements may be provided:
the product dispensing system 4 is provided in at least one among the glass container body 2 and the closure system 3;
the product dispensing system 4 comprises a first dispensing sub-system 63 for discharging the product that may be contained in the first receptacle 61, and a second dispensing sub-system 64 for discharging the product that may be contained in the second receptacle 62;
the first and second dispensing sub-systems 63, 64 are heterogeneous;
the first dispensing sub-system 63 is provided in the closure system 3;
the second dispensing sub-system 64 is provided in the closure system 3;
the product dispensing system 4 is provided in the closure system 3;
the product dispensing system 4 is not suitable for an alternative dispensing of the product that may be contained in at least two receptacles 61, 62;
the product dispensing system 4 is suitable for an alternative dispensing of the product that may be contained in at least two receptacles 61, 62;
the product dispensing system 4 is suitable for alternatively dispensing either an alternative dispensing or a combined dispensing of the product that may be contained in at least two receptacles 61, 62;
the closure system 3 is permanently assembled to the glass container system 2;
the product dispensing system 4 comprises the closure system 3 mounted so as to be movable between a closed configuration where the products that may be contained in the mutually fluidtight containers are inaccessible, and an open configuration where the products are accessible;
at least two receptacles 61, 62 have at least one of the following features:
   an identical external shape,
   an external shape that is symmetrical to one another,
   an external shape that is different from one another,
   an external shape that is asymmetrical to one another,
   an identical internal shape,
an internal shape that is symmetrical to one another,
   an internal shape that is different from one another,
   an internal shape that is asymmetrical to one another,
   an identical volume plus or minus 10%,
   a volume that differs by at least 10%,
   a volume that differs by at least 50%,
   identical external decoration,
   different external decoration,
   identical internal decoration,
   different internal decoration;
the glass container body 5 comprises a first container 6 and a second container 7, the first container 6 comprises a first assembly portion 65, the second container 7 comprises a second assembly portion 66, the closure system 3 comprises a first assembly portion 67 and a second assembly portion 68, the first assembly portion 65 of the first container 6 is hermetically assembled to the first assembly portion 67 of the closure system 3 so as to define the first receptacle 61, and the second assembly portion 66 of the second container 7 is hermetically assembled to the second assembly portion 68 of the closure system 3 so as to define the second receptacle 62;
the bottle comprises a bearing surface 10, the bottle being intended to be placed with its bearing surface resting on a support during normal use of the bottle;
during normal use, at least one receptacle 61, 62 is defined by a lower portion that is part of the glass container and by an upper portion that is part of the closure system;
the receptacles 61, 62 are side by side;
the receptacles 61, 62 are nested one inside the other;
during normal use, at least one of the receptacles 61, 62 has an elongated shape along the vertical direction;
the first and second receptacles are assembled together permanently;
the dispensing system allows dispensing the product through a first dispensing hole 32, the glass container body comprising a mouth 13 hermetically assembled to the closure system 3 to form the first receptacle, the cross-sectional area of the mouth 13 being at least twice that of the first dispensing hole 32;
the bottle comprises a solid object 83, 84 inside the first receptacle, the object being of dimensions between the cross-sectional dimensions of the mouth 13 and those of the first dispensing hole 32;
the object 83, 84 is assembled to the closure system 3;
the single glass container body comprises at least one mouth 13, the closure system defines a first dispensing through-hole 32, the dispensing system enables dispensing product through the first dispensing hole 32, the glass container body comprising a mouth 13 hermetically assembled to the closure system 3 to form the first receptacle, the cross-sectional area of the mouth 13 being at least twice that of the first dispensing hole 32;
the closure system comprises a sealing part 19 and a locking part 21, the sealing part 19 comprises a cover 22 for closing the mouth 13 and a system for assembly to a product dispensing system 4, the cover 22 comprises a sealing portion 22a and a neck 31 extending axially from the sealing portion 22a, and the neck 31 defines the first dispensing through-hole 32;
the neck 31 extends axially upward from the sealing portion 22a;
the dispensing system enables dispensing product through a first dispensing hole 32, the glass container body comprising a mouth 13 hermetically assembled to the closure system 3 to form the first receptacle, the shape of the cross-section of the radially inner surface 28 of the glass container body at the mouth 13 being non-circular;
a system comprising a bottle, and a first product and a second product each contained in a respective one of the two receptacles 61, 62.
such a system, wherein the first and second products differ in at least one of the following characteristics:
   chemical composition,
   density
   dilution factor,
   viscosity;
a method for producing a bottle comprises:
   the production of a glass container system 2 comprising a plurality of glass container bodies 5,
   the hermetic and permanent assembly of a closure system 3 to the glass container system 2, the glass container system 2 and the closure system 3 being assembled to one another so as to define at least first and second separate receptacles 61, 62 that are sealed in relation to one another,
      a product dispensing system 4 for discharging from the bottle the product that may be contained in the receptacles 61, 62;
the glass container body 5 is produced by pressing;
two containers 6, 7 are produced in the glass container body by implementing a pressing step;
two containers 6, 7 are produced in the glass container body by implementing a simultaneous pressing step;
the closure system 3 is assembled to the glass container system 2 so as to define the receptacles 61, 62 simultaneously.

According to a third invention, a bottle is provided comprising:
a glass container system 2 comprising at least one glass container body 5,
a closure system 3 hermetically assembled to the glass container system 2, the glass container system 2 and the closure system 3 being assembled to each other so as to define at least first and second separate receptacles 61, 62 that are sealed in relation to one another,
a product dispensing system 4 for discharging from the bottle the product that may be contained in the receptacles 61, 62, and comprising the closure system mounted so as to be movable between a closed configuration where the products that may be contained in the mutually fluidtight containers are inaccessible, and an open configuration where the products are accessible.

In various aspects of this third invention, one or more of the following arrangements may be provided:
the product dispensing system 4 is provided in at least one among the glass container body 2 and the closure system 3;
the product dispensing system 4 comprises a first dispensing sub-system 63 for discharging the product that may be contained in the first receptacle 61, and a second dispensing sub-system 64 for discharging the product that may be contained in the second receptacle 62;
the first and second dispensing sub-systems 63, 64 are heterogeneous;
the first dispensing sub-system 63 is provided in the closure system 3;
the second dispensing sub-system 64 is provided in the closure system 3;
the product dispensing system 4 is provided in the closure system 3;
the product dispensing system 4 is not suitable for an alternative dispensing of the product that may be contained in at least two receptacles 61, 62;
the product dispensing system 4 is suitable for an alternative dispensing of the product that may be contained in at least two receptacles 61, 62;
the product dispensing system 4 is suitable for alternatively dispensing either an alternative dispensing or a combined dispensing of the product that may be contained in at least two receptacles 61, 62;
the glass container system comprises a single glass container body;
the glass container system comprises a plurality of glass container bodies;
the at least two receptacles 61, 62 have at least one of the following features:
   an identical external shape,
   an external shape that is symmetrical to one another,
   an external shape that is different from one another,
   an external shape that is asymmetrical to one another,
   an identical internal shape,
   an internal shape that is symmetrical to one another,
   an internal shape that is different from one another,
   an internal shape that is asymmetrical to one another,
   an identical volume plus or minus 10%,
   a volume that differs by at least 10%,
   a volume that differs by at least 50%,
   identical external decoration,
   different external decoration,
   identical internal decoration,
   different internal decoration;
the glass container body 5 comprises a first container 6 and a second container 7, the first container 6 comprises a first assembly portion 65, the second container 7 comprises a second assembly portion 66, the closure system 3 comprises a first assembly portion 67 and a second assembly portion 68, the first assembly portion 65 of the first container 6 is hermetically assembled to the first assembly portion 67 of the closure system 3 so as to define the first receptacle 61, and the second assembly portion 66 of the second container 7 is hermetically assembled to the second assembly portion 68 of the closure system 3 so as to define the second receptacle 62;
the bottle comprises a bearing surface 10, the bottle being intended to be placed with its bearing surface resting on a support during normal use of the bottle;
during normal use, at least one receptacle 61, 62 is defined by a lower portion that is part of the glass container and by an upper portion that is part of the closure system;
the receptacles 61, 62 are side by side;
the receptacles 61, 62 are nested one inside the other;
during normal use, at least one of the receptacles 61, 62 has an elongated shape along the vertical direction;
the first and second receptacles are assembled together permanently;
the dispensing system enables dispensing the product through a first dispensing hole 32, the glass container body comprising a mouth 13 hermetically assembled to the closure system 3 to form the first receptacle, the cross-sectional area of the mouth 13 being at least twice that of the first dispensing hole 32;
the bottle comprises a solid object 83, 84 inside the first receptacle, the object being of dimensions between the cross-sectional dimensions of the mouth 13 and those of the first dispensing hole 32;
the object 83, 84 is assembled to the closure system 3;
a glass container body comprises at least one mouth 13, the closure system defines a first dispensing through-hole 32, the dispensing system enables dispensing product through the first dispensing hole 32, the glass container body comprising a mouth 13 hermetically assembled to the closure system 3 to form the first receptacle, the cross-sectional area of the mouth 13 being at least twice that of the first dispensing hole 32;
the closure system comprises a sealing part 19 and a locking part 21, the sealing part 19 comprises a cover 22 for closing the mouth 13 and a system for assembly to a product dispensing system 4, the cover 22 comprises a sealing portion 22a and a neck 31 extending axially from the sealing portion 22a, and the neck 31 defines the first dispensing through-hold 32;
the neck 31 extends axially upward from the sealing portion 22a;
the dispensing system enables dispensing product through a first dispensing hole 32, the glass container body comprising a mouth 13 hermetically assembled to the closure system 3 to form the first receptacle, the shape of the cross-section of the radially inner surface 28 of the glass container body at the mouth 13 being non-circular;
a system comprising a bottle, and a first product and second product each contained in a respective one of the two receptacles 61, 62.
such a system, wherein the first and second products differ in at least one of the following characteristics:
   chemical composition,
   density
   dilution factor,
   viscosity;
a method for producing a bottle comprises:
   the production of a glass container system 2 comprising at least one glass container body 5,
   the hermetic assembly of a closure system 3 to the glass container system 2, the glass container system 2 and the closure system 3 being assembled to one another so as to define at least first and second separate receptacles 61, 62 that are sealed in relation to one another,
      a product dispensing system 4 enabling discharging from the bottle the product that may be contained in the receptacles 61, 62, comprising the closure system mounted so as to be movable between a closed configuration where the products that may be contained in the mutually fluidtight containers are inaccessible, and an open configuration where the products are accessible;
the glass container body 5 is produced by pressing;
two containers 6, 7 are produced in the glass container body by implementing a pressing step;
two containers 6, 7 are produced in the glass container body by implementing a simultaneous pressing step;
the closure system 3 is assembled to the glass container system 2 so as to define the receptacles 61, 62 simultaneously.

1. A bottle, wherein the bottle comprises:
a glass container system comprising a single glass container body,
a closure system hermetically and permanently assembled to the glass container system, the glass container system and the closure system being assembled to each other so as to define at least first and second separate receptacles that are sealed in relation to one another,
a product dispensing system for discharging from the bottle the product that may be contained in the receptacles.

2. The bottle according to claim 1, wherein the product dispensing system is provided in at least one among the glass container body and the closure system.

3. The bottle according to claim 2, wherein the product dispensing system comprises a first dispensing sub-system for discharging the product that may be contained in the first receptacle, and a second dispensing sub-system for discharging the product that may be contained in the second receptacle.

4. The bottle according to claim 3, wherein the first and second dispensing sub-systems are heterogeneous.

5. (canceled)

6. (canceled)

7. (canceled)

8. (canceled)

9. The bottle according to claim 1, wherein the at least two receptacles have at least one of the following features:
an identical external shape,
an external shape that is symmetrical to one another,
an external shape that is different from one another,
an external shape that is asymmetrical to one another,
an identical internal shape,
an internal shape that is symmetrical to one another,
an internal shape that is different from one another,
an internal shape that is asymmetrical to one another,
an identical volume plus or minus 10%,
a volume that differs by at least 10%,
a volume that differs by at least 50%,
identical external decoration,
different external decoration,
identical internal decoration,
different internal decoration.

10. The bottle according to claim 1, wherein the glass container body comprises a first container and a second container, wherein the first container comprises a first assembly portion, wherein the second container comprises a second assembly portion, wherein the closure system comprises a first assembly portion and a second assembly portion, wherein the first assembly portion of the first container is hermetically assembled to the first assembly portion of the closure system so as to define the first receptacle, and wherein the second assembly portion of the second container is hermetically assembled to the second assembly portion of the closure system so as to define the second receptacle.

11. The bottle according to claim 1 comprising a bearing surface, the bottle being intended to be placed with its bearing surface resting on a support during normal use of the bottle.

12. The bottle according to claim 11, wherein, during normal use, at least one receptacle is defined by a lower portion that is part of the glass container and by an upper portion that is part of the closure system.

13. The bottle according to claim 11, wherein the receptacles are side by side.

14. The bottle according to claim 11, wherein the receptacles are nested one inside the other.

15. The bottle according to claim 11, wherein, during normal use, at least one of the receptacles has an elongated shape along the vertical direction.

16. The bottle according to claim 1, wherein the first and second receptacles are assembled together permanently.

17. The bottle according to claim 1, wherein the dispensing system enables dispensing the product through a first dispensing hole, the glass container body comprising a mouth hermetically assembled to the closure system to form the first receptacle, the cross-sectional area of the mouth being at least twice that of the first dispensing hole.

18. The bottle according to claim 17, comprising a solid object inside the first receptacle, the object being of dimensions between the cross-sectional dimensions of the mouth and those of the first dispensing hole.

19. The bottle according to claim 18, wherein the object is assembled to the closure system.

20. The bottle according to claim 1,
wherein the single glass container body comprises at least one mouth,
wherein the closure system defines a first dispensing through-hole,
wherein the dispensing system enables dispensing product through the first dispensing hole, the glass container body comprising a mouth hermetically assembled to the closure system to form the first receptacle, the cross-sectional area of the mouth being at least twice that of the first dispensing hole.

21. The bottle according to claim 20, wherein the closure system comprises a sealing part and a locking part,
wherein the sealing part comprises a cover for closing the mouth and a system for assembly to a product dispensing system,
wherein the cover comprises a sealing portion and a neck extending axially from the sealing portion,
and wherein the neck defines the first dispensing through-hole.

22. The bottle according to claim 21, wherein the neck extends axially upward from the sealing portion.

23. The bottle according to claim 1, wherein the dispensing system enables dispensing product through a first dispensing hole, the glass container body comprising a mouth hermetically assembled to the closure system to form the first receptacle, the shape of the cross-section of the radially inner surface of the glass container body at the mouth being non-circular.

24. (canceled)

25. (canceled)

26. (canceled)

27. (canceled)

28. (canceled)

29. (canceled)

30. (canceled)

31. A bottle, wherein the bottle comprises:
a glass container system comprising at least two glass container bodies,
a closure system hermetically assembled to the glass container system, the glass container system and the closure system being assembled to each other so as to define at least first and second separate receptacles that are sealed in relation to one another,
a product dispensing system for discharging from the bottle the product that may be contained in the receptacles.

32. A bottle, wherein the bottle comprises:
a glass container system comprising at least one glass container body,
a closure system hermetically assembled to the glass container system, the glass container system and the closure system being assembled to each other so as to define at least first and second separate receptacles that are sealed in relation to one another,
a product dispensing system for discharging from the bottle the product that may be contained in the receptacles and comprising the closure system mounted so as to be movable between a closed configuration where the products that may be contained in the mutually fluidtight containers are inaccessible, and an open configuration where the products are accessible.
